(19) United States
(12) Patent Application Publication
(10) Pub. No.: US 2026/0296365 A1
(43) Pub. Date: Oct. 1, 2026

(54) VEHICLE SYSTEM AND VEHICLE CONTROL METHOD

(71) Applicant: HONDA MOTOR CO., LTD., Tokyo (JP)

(72) Inventors: Genki Inohana, Tokyo (JP); Toku Segawa, Tokyo (JP); Seonghun Lee, Tokyo (JP); Mitsunori Nishino, Tokyo (JP)

(21) Appl. No.: 19/576,465

(22) Filed: Mar. 24, 2026

(30) Foreign Application Priority Data
Mar. 28, 2025 (JP) 2025-057256

(51) Int. Cl. B60R 25/01; B60R 25/30; B60R 25/31; G06V 10/82; G06V 20/58; G06V 40/16; G06V 40/20

(52) U.S. Cl. CPC B60R 25/01; B60R 25/305; B60R 25/31; G06V 10/82; G06V 20/58; G06V 40/171; G06V 40/20

(57) ABSTRACT

In a vehicle system, an exit detection unit performs, based on a captured image, a first detection processing of detecting whether a first condition is satisfied, the first condition indicating that a person detected by a person detection unit is present near a door of a vehicle, and a second detection processing of detecting whether a second condition is satisfied, the second condition indicating that the detected person is moving away from the vehicle, and detects the detected person as a person having exited from the vehicle when the first condition and the second condition are satisfied. The vehicle system includes a vehicle control unit that performs vehicle control at a time of exiting when the exit detection unit detects that the detected person is a person having exited from the vehicle.

### INCORPORATION BY REFERENCE

The present application claims priority under 35 U.S.C.§119 to Japanese Patent Application No.2025-057256 filed on Mar. 28, 2025. The content of the application is incorporated herein by reference in its entirety.

### BACKGROUND OF THE INVENTION

### FIELD OF THE INVENTION

The present invention relates to a vehicle system and a vehicle control method.

### DESCRIPTION OF THE RELATED ART

A disclosed arrangement for a control system for controlling a vehicle includes: a person detection unit that detects a person based on a captured image composed of a moving image captured outside the vehicle; and an exit detection unit that detects a person outside the vehicle as an exiting person when the image area of the detected person decreases from a value equal to or greater than a predetermined value (see, for example, Japanese Patent Laid-Open No. 2023-148786).

However, conventional arrangements may mistakenly detect a passerby as an exiting person, and this can therefore lead to inaccurate identification of an exiting person when a passerby is present, resulting in inappropriate vehicle control at a time of exiting and reduced convenience.

An object of the present invention, which has been made in consideration of this background, is to properly detect a person exiting from a target vehicle even in a situation where a passerby is present, to perform appropriate vehicle control, improving convenience.

### SUMMARY OF THE INVENTION

An aspect of the present disclosure may be a vehicle system including: a person detection unit that detects a person based on a captured image composed of a moving image captured outside a vehicle; an exit detection unit that detects whether the detected person is a person having exited from a target vehicle, wherein the exit detection unit performs, based on the captured image, a first detection processing of detecting whether a first condition is satisfied, the first condition indicating that the detected person is present near a target door of the target vehicle, and a second detection processing of detecting whether a second condition is satisfied, the second condition indicating that the detected person is moving away from the target vehicle, and detects the detected person as a person having exited from the target vehicle when the first condition and the second condition are satisfied; and a vehicle control unit that performs vehicle control at a time of exiting when the exit detection unit detects that the detected person is a person having exited from the target vehicle.

Another aspect of the present disclosure may be a vehicle control method executed by a computer, the method including: a person detection step of a person detection unit detecting a person based on a captured image composed of a moving image captured outside a vehicle; an exit detection step of an exit detection unit detecting whether the detected person has exited from a target vehicle; and a vehicle control step of a vehicle control unit performing vehicle control at a time of exiting when the detected person is detected as a person having exited from the target vehicle, wherein the exit detection step performs, based on the captured image, a first detection processing of detecting whether a first condition is satisfied, the first condition indicating that the detected person is present near a target door of the target vehicle, and a second detection processing of detecting whether a second condition is satisfied, the second condition indicating that the detected person is moving away from the target vehicle, and detects the detected person as a person having exited from the target vehicle when the first condition and the second condition are satisfied.

### Advantageous Effects of Invention

The aspects of the present invention makes it possible to properly detect a person exiting from a target vehicle even in a situation where a passerby is present, and appropriately perform vehicle control, improving convenience.

### BRIEF DESCRIPTION OF THE DRAWINGS

FIG. 1 is a diagram showing a configuration of a vehicle equipped with a vehicle system;

FIG. 2 is a diagram showing an imaging range of a left camera;

FIG. 3 is a block diagram showing a control system of the vehicle;

FIG. 4 is a diagram showing an example of a captured image;

FIG. 5 is a diagram for describing a second detection processing; and

FIG. 6 is a flowchart showing an operation of a vehicle control device.

### DETAILED DESCRIPTION OF THE PREFERRED EMBODIMENTS

Hereinafter, embodiments of the present invention will be described with reference to the drawings.

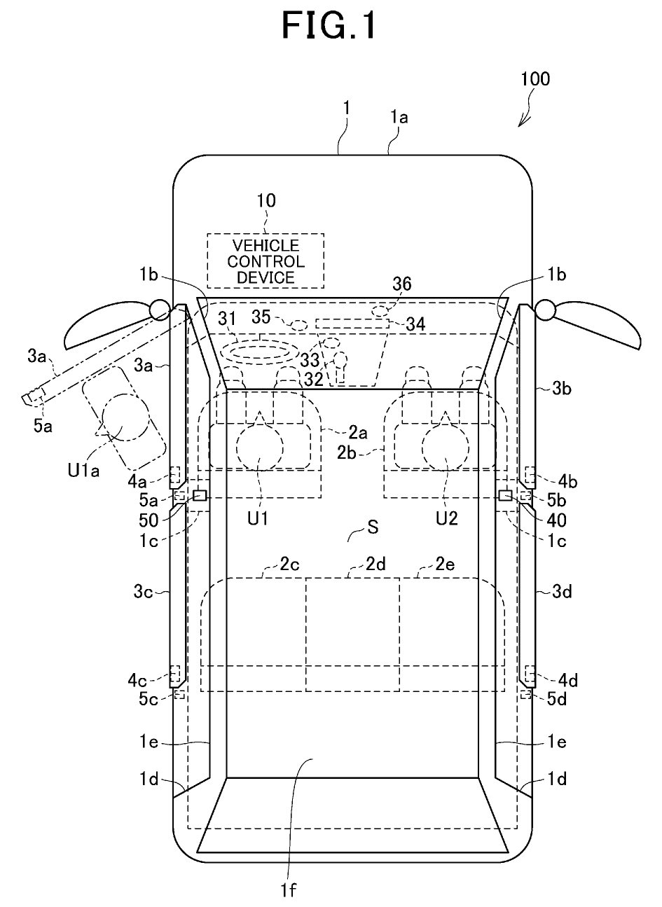

FIG. 1 is a diagram showing a configuration of a vehicle 1 equipped with a vehicle system 100 according to an embodiment of the present invention. This vehicle system 100 includes a vehicle control device 10 provided in the vehicle 1, and door lock mechanisms 4a to 4d that are provided in the vehicle 1 and electrically connected to the vehicle control device 10. In the following description, directions such as front, rear, left, right, up, and down are the same as directions relative to the vehicle body 1a unless otherwise specified.

### 1. Vehicle Configuration

The configuration of the vehicle 1 will be described with reference to FIG. 1.

The vehicle 1 is a four-wheeled automobile including a vehicle body 1a having a vehicle interior S that is the passenger space for occupants, the vehicle body 1a being equipped with multiple opening/closing bodies that open the passenger compartment S to the outside.

The vehicle interior S has a driver's seat 2a, a passenger seat 2b, a rear left seat 2c, a rear center seat 2d, and a rear right seat 2e arranged therein. FIG. 1 shows a situation in which user U1 who is a driver, is sitting in the driver's seat 2a, and a user U2, who is a passenger, is sitting in the passenger seat 7.

The vehicle 1 has a structure that has a vehicle body 1a that includes left and right front pillars 1b, center pillars 1c, rear pillars 1d, side rails 1e, and a roof panel 1f, all of which surround the vehicle interior S. However, the structure of the vehicle 1 including the vehicle body 1a may be modified as appropriate.

The vehicle 1 includes multiple opening/closing bodies: a left door 3a, a right door 3b, a rear left door 3c, and a rear right door 3d. The left door 3a is opened when the user U1 in the driver's seat 2a moves outside the vehicle, and when the user U1 enters the driver's seat 2a from outside the vehicle. The right door 3b is opened when the user U2 in the passenger seat 2b moves outside the vehicle, and when the user U2 enters the passenger seat 2b from outside the vehicle. Furthermore, the rear left door 3c and the rear right door 3d are opened when users in the rear seats 2c to 2e move outside the vehicle, or when users enter the rear seats 2c to 2e from outside the vehicle. In this embodiment, each of the doors 3a to 3d is a hinged door.

The vehicle 1 is equipped with door lock mechanisms 4a to 4d that respectively lock and unlock the doors 3a to 3d, and door sensors 5a to 5d that respectively sense the opening/closing of doors 3a to 3d.

In FIG. 1, the state where the left door 3a is open is indicated by two-dot chain lines, and there is shown an exiting user U1a who is the driver (user U1) immediately after opening the left door 3a and moving outside the vehicle.

The vehicle 1 includes a steering wheel 31, a gear selector 32, an ignition switch 33, and a touch panel 34, as an operating system to be used by the user U1 sitting in the driver's seat 2a for driving and the like. The gear selector 32 is an operator for selecting gears and drive modes, and is provided as a shift lever or a mode switch depending on the specifications of the vehicle 1. In addition, the vehicle 1 also is equipped with a microphone 35 that collects sound from within the passenger compartment S, and a speaker 36 that outputs sound into the vehicle interior S.

Furthermore, vehicle 1 is equipped with cameras 41a and 41b for capturing images outside the vehicle.

The camera 41a is attached to the left center pillar 1c, and is an exterior-imaging camera capable of imaging the user U1 who has opened at least the left door 3a and has exited, that is, the "exiting user U1a" who is the driver. This camera 41a can also capture images in a situation in which the exiting user U1a is moving away from the vehicle 1.

In this embodiment, the vehicle 1 is a left-hand drive vehicle, and the left camera 41a can be used to image the driver having exited.

The right camera 41b is positioned symmetrically to the left camera 41a, and in the case of a right-hand drive vehicle, it can image the driver having exited (exiting user U1a). In the case of a left-hand drive vehicle, the right camera 41b can image the user U2 having exited from the passenger seat 2b. The right camera 41b has the same functions as the camera 41a, except that it is positioned symmetrically to camera 41a, and therefore further description of the right camera 41b will be omitted as appropriate.

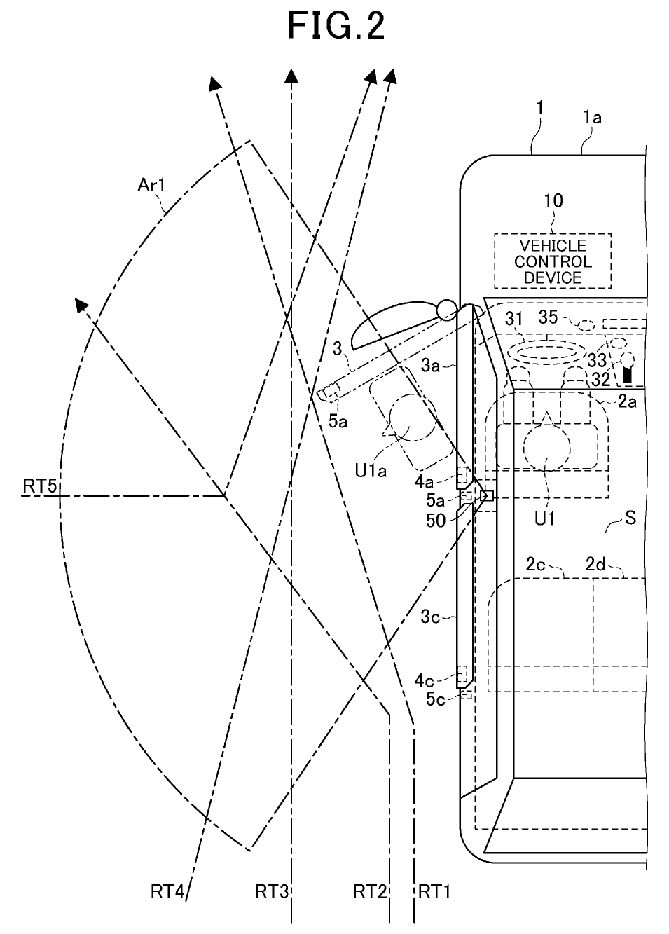

With reference to FIG. 2, the imaging range of the left camera 41a will be described.

As shown in FIG. 2, for the camera 41a, the installation angle, the horizontal field of view, the vertical field of view, and the like of the camera 41a are set so that it can image a person within a target area Ar1 shown in FIG. 2.

In this embodiment, the target area Ar1 is set to an area that can image the front seat exiting user U1a who has opened the left door 3a and has exited, as well as rear seat users who have opened the rear left door 3c and have exited, that is, users who have exited from the rear seats 2c to 2e to the left side of the vehicle body. Furthermore, a wide-angle lens is used for a lens of the camera 41a, making it possible to image a person within the target area Ar1 of a wide range shown in FIG. 2. This allows camera 41a to image not only the user U1 exiting from the left door 3a, but also users exiting from the rear left door 3c.

For example, the camera 41a images a person within a sector-shaped target area Ar1 ranging from 90° to 150° horizontally and from 90° to 150° vertically, within a range of at least 1.6 m horizontally with reference to the vehicle 1. This makes it possible to capture images of all users having exited on the left side of the vehicle, and to continue capturing images until the user moves approximately 1.6 m away from the vehicle 1.

Because the camera 41a is attached to the center pillar 1c, it can also image the open left door 3a, which is located on the opposite side of the camera 41a across from the exiting user U1a. In other words, the camera 41a can image at least the open left door 3a and the exiting user U1a who is located between this left door 3a and the camera 41a.

The multiple routes RT1 to RT5 shown in FIG. 2 are examples of routes taken by passersby on the left side of the vehicle 1. Since these routes RT1 to RT5 pass through the target area Ar1, there is a high probability that passersby traveling along routes RT1 to RT5 will be imaged by the camera 41a.

The camera 41a is positioned so that it can image at least the upper body, including the face, of a person within the target area Ar1. For example, the camera 41a is positioned horizontally or slightly diagonally downward around the upper part of the center pillar 1c to image at least the upper body, including the face, of an exiting user U1a and a passerby. Imaging the upper body, including the face, increases the accuracy of detecting an exiting user U1a. Furthermore, the camera 41a can image almost the entire body of the exiting user U1a when he or she moves a certain distance away from the vehicle 1.

For the camera 41a, there is employed a color or monochrome video camera that captures moving images. However, the camera 41a only needs to be able to capture images of the open left door 3a and the exiting user U1a positioned between the left door 3a and the camera 41a, and its specific specifications, position, and imaging range may be changed as appropriate.

For example, instead of the center pillar 1c, the camera 41a may be positioned on a peripheral member located around the center pillar 1c. The peripheral member may be a structure such as the center pillar 1c or the side rail 1e. The camera 41a may also be positioned inside the vehicle near the center pillar 1c to capture images of the outside of the vehicle from inside the vehicle. The number of the cameras 41a is not limited to one, and may be two or more.

### 2. Configuration of Vehicle Control Device 10

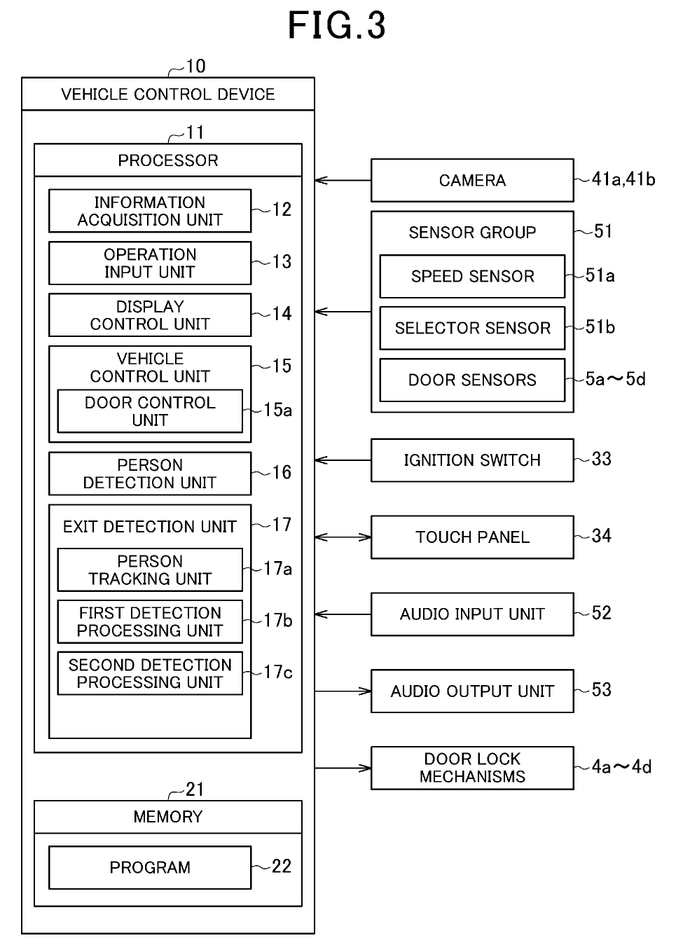

FIG. 3 is a block diagram showing the control system of the vehicle 1. The control system of the vehicle 1 includes a vehicle control device 10 and components mounted on the vehicle body such as cameras 41a and 41b provided on the vehicle 1, which are connected to the vehicle control device 10. The vehicle control device 10 can also be referred to as an on-board device mounted on the vehicle 1.

The vehicle control device 10 includes a processor 11 and a memory 21. The processor 11 is a computer constituted of a CPU (Central Processing Unit), an MCU (Micro Controller Unit), or an MPU (Micro Processor Unit).

The memory 21 is a rewritable non-volatile storage device that stores a program 22 executed by the processor 11 and data processed by the processor 11. The memory 21 may be constituted of, for example, a semiconductor storage device such as a flash ROM (Read Only Memory) or an SSD (Solid State Disk), or a magnetic storage device. The memory 21 may also include a RAM (Random Access Memory), which serves as a working area for temporarily storing the program 22 and data. The vehicle control device 10 may also be constituted of, for example, an integrated circuit (IC) integrating the processor 11 and the memory 21.

The vehicle control device 10 is connected to cameras 41a and 41b, a sensor group 51, an ignition switch 33, a touch panel 34, an audio input unit 52, an audio output unit 53, and door lock mechanisms 4a to 4d.

Under the control of the vehicle control device 10, the cameras 41a and 41b acquire captured images composed of moving images captured outside the vehicle, and output image data of the captured images to the vehicle control device 10.

The sensor group 51 is a group of multiple sensors that acquires information from various parts of the vehicle 1 and outputs the acquired information to the vehicle control device 10. The sensor group 51 includes a speed sensor 51a that detects the traveling speed of the vehicle 1, a selector sensor 51b that detects the operating position of the gear selector 32, and door sensors 5a to 5d that sense the opening/closing and locking/unlocking of the doors 3a to 3d.

The ignition switch 33 is a switch that the user U1, who is the driver, turns on when using the vehicle 1 and turns off when finishing to use the vehicle 1. The ignition switch 33 is also referred to as a start switch or a power switch.

The touch panel 34 includes a display panel that displays various images and a touch sensor that detects touch operations on the display panel. The touch panel 34 outputs user instructions detected through touch operations of the user U1 or others to the vehicle control device 10.

The audio input unit 52 includes a microphone 35 and a circuit that amplifies and performs analog-to-digital conversion on the audio input via the microphone 35. The audio input unit 52 outputs the audio data input via the microphone 35 to the vehicle control device 10. The audio input unit 52 is used, for example, to realize audio control in which the user U1 gives various instructions by voice.

The audio output unit 53 includes a speaker 36 and a drive circuit for driving the speaker 36, and outputs various sounds to the vehicle interior S under the control of the vehicle control device 10.

The door lock mechanisms 4a to 4d controls locking/unlocking of the doors 3a to 3d under the control of the vehicle control device 10.

The processor 11 reads and executes the program 22 stored in the memory 21 to function as an information acquisition unit 12, an operation input unit 13, a display control unit 14, a vehicle control unit 15, a person detection unit 16, and an exit detection unit 17.

The information acquisition unit 12 acquires images captured by the cameras 41a and 41b and information detected by the sensor group 51.

Note that the information acquisition unit 12 may also have a function of acquiring various information from a server or the like connected to the Internet via a communication unit (not shown). In this case, the program 22 can be updated, for example, by acquiring update data for the program 22 from a server connected to the Internet.

The operation input unit 13 inputs operations and user instructions from the user U1 via the ignition switch 33, the touch panel 34, and the audio input unit 52.

The display control unit 14 controls the images displayed on the display panel of the touch panel 34 based on the user instructions input via the operation input unit 13.

The vehicle control unit 15 performs processing to control various parts of the vehicle 1. In this embodiment, the vehicle control unit 15 includes a door control unit 15a. The door control unit 15a outputs signals to control the operations of the door lock mechanisms 4a to 4d to switch locking/unlocking of the doors 3a to 3d, respectively.

The person detection unit 16 performs processing to detect a person in images captured by the camera 41a.

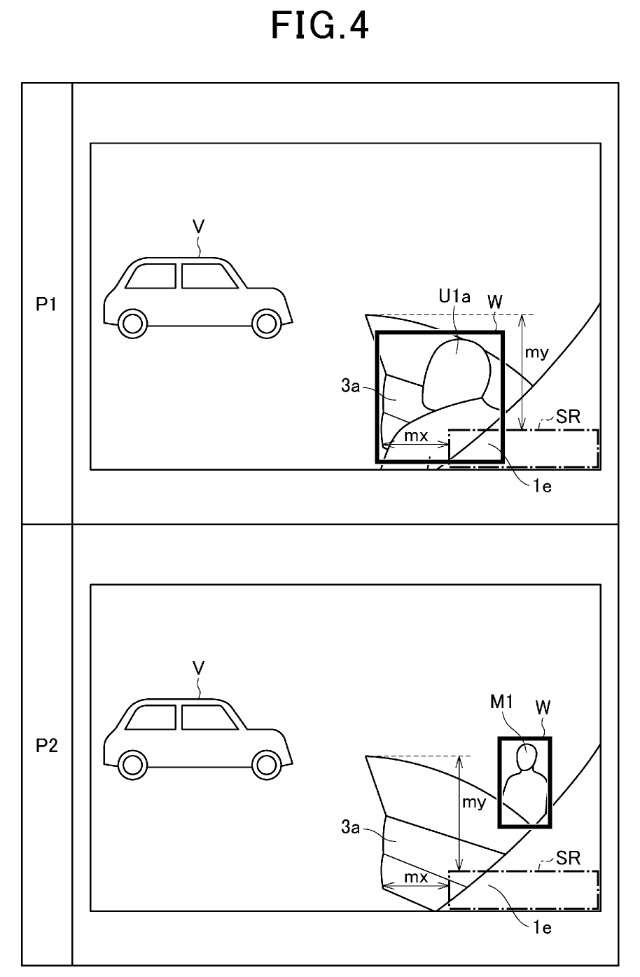

FIG. 4 is a diagram showing examples of images captured by the camera 41a.

The captured image P1 shown in FIG. 4 is an image captured immediately after the user U1, who is the driver, opens the left door 3a and exits, and the images of the exiting user U1a and the left door 3a are captured. In contrast, the captured image P2 shown in FIG. 4 shows a situation in which the exiting user U1a is absent and a passerby is captured within the imaging range (corresponding to the range of target area Ar1).

The captured images P1 and P2 also capture the side rail 1e, which is one of the peripheral members of the door opening to be closed by the left door 3a, and may also capture another vehicle V parked around the vehicle 1.

The person detection unit 16 will be described with reference to FIG. 4.

The person detection unit 16 detects a person in the captured image by performing object detection processing using known image recognition technology. More specifically, the person detection unit 16 detects the presence or absence of a person based on the captured image composed of the moving image by using image recognition technology that detects facial and body features and/or artificial intelligence technology using deep learning.

The person detection unit 16 also generates a rectangular frame W (see FIG. 4) that surrounds the region of the detected person in each frame of the captured image. This frame W, also known as a bounding box, is the smallest rectangular frame that surrounds the detected person, and can be used as information indicating the position and size of the detected person.

Furthermore, the person detection unit 16 also performs vehicle door detection processing by using image recognition technology that detects vehicle door features in addition to person features and/or artificial intelligence technology using deep learning. This makes it possible to detect the presence or absence of the left door 3a in the captured image composed of the moving image.

The image captured by camera 41a may capture the exiting user U1a who is the driver immediately after exiting (captured image P1), a passerby M1 (FIG. 4) (captured image P2), or a user having exited from the rear left door 3c. As a result, a frame W surrounding the exiting user U1a is generated in the captured image P1, and a frame W surrounding a passerby M1 is generated in the captured image P2.

As shown in FIG. 4, in captured image P1, the exiting user U1a and the left door 3a are located in the lower right region, and the exiting user U1a overlaps with the left door 3a. As a result, the person detection unit 16 performs person and door detection processing in the lower right region where the exiting user U1a and the left door 3a are expected to be, thereby making it possible to reduce the amount of calculation required to detect the exiting user U1a and the left door 3a. It is also possible to prevent detection of a user having exited from the rear left door 3c.

As shown in captured image P2, a passerby M1 may be captured in the lower right region. Therefore, the person present in the lower right region of the captured image is not necessarily the exiting user U1a.

In this embodiment, as described below, a person overlapping the door in the captured image is detected as the exiting user U1a, making it possible to distinguish between passerby M1 and the exiting user U1a. Furthermore, the person detection unit 16 can also perform person and vehicle door detection processing for the entire area of the captured image.

Because the other vehicle V captured in each of the captured images P1 and P2 shown in FIG. 4 is not a detection target of the person detection unit 16, the presence of the other vehicle V does not affect the detection of the exiting user U1a. However, if detection of the other vehicle V is necessary, the other vehicle V can also be detected by the person detection unit 16.

The exit detection unit 17 shown in FIG. 3 performs processing to confirm an exit intention of the driver of the vehicle 1 (user U1). The exit detection unit 17 includes a person tracking unit 17a, a first detection processing unit 17b, and a second detection processing unit 17c.

The person tracking unit 17a has a function of tracking a person that is the detection target based on the person detection result in successive frames of the captured image composed of the moving image captured by the camera 41a. The tracking processing generates a frame W that surrounds the same person for each frame.

The first detection processing unit 17b performs first detection processing to detect whether the person detected by the person detection unit 16 is the exiting user U1a. The first detection processing uses well-known image recognition technology to detect whether the detected person satisfies a first condition that the person is present in a position overlapping with the vehicle door based on the captured image, thereby detecting whether the detected person is the exiting user U1a.

As shown in FIG. 4, when the frame W surrounding the detected exiting user U1 includes a predetermined region SR, which is either a left region or a right region at the lower part of the captured image P1 and is the lower right region SR in this embodiment, and overlaps with the left door 3a, the frame W is determined to satisfy the first condition. This allows for highly accurate detection of the exiting user U1a immediately after exiting from the driver's seat 2a, and can prevent erroneous detection of a user having exited from the rear seat or a passerby M1.

Here, the predetermined region SR is set to a region that does not overlap with the frame W surrounding the detected passerby M1. In this configuration, the predetermined region SR is set to the lower right region, provided with a margin mx between the predetermined region SR and the width direction end portion of the left door 3a and a margin my between the predetermined region SR and the upper end of the left door 3a, thereby setting a region that does not overlap with the frame W surrounding the detected passerby M1.

The margin mx is set to a value that prevents a passerby M1 (e.g., the frame W surrounding the passerby M1) from overlapping with the predetermined region SR even when part of the passerby M1 protrudes from the left door 3a, in other words, is set to a value that prevents the passerby M1 from being mistakenly determined to be the exiting user U1a.

The margin my is set to a value that prevents a passerby M1 (e.g., the frame W surrounding the passerby M1) from overlapping the predetermined region SR even when the frame W surrounding the passerby M1 varies, in other words, is set to a value that prevents the passerby M1 from being mistakenly determined to be the exiting user U1a.

The second detection processing unit 17c performs second detection processing to detect whether the detected person satisfies a second condition that the person is moving away from the vehicle 1, based on the tracking result.

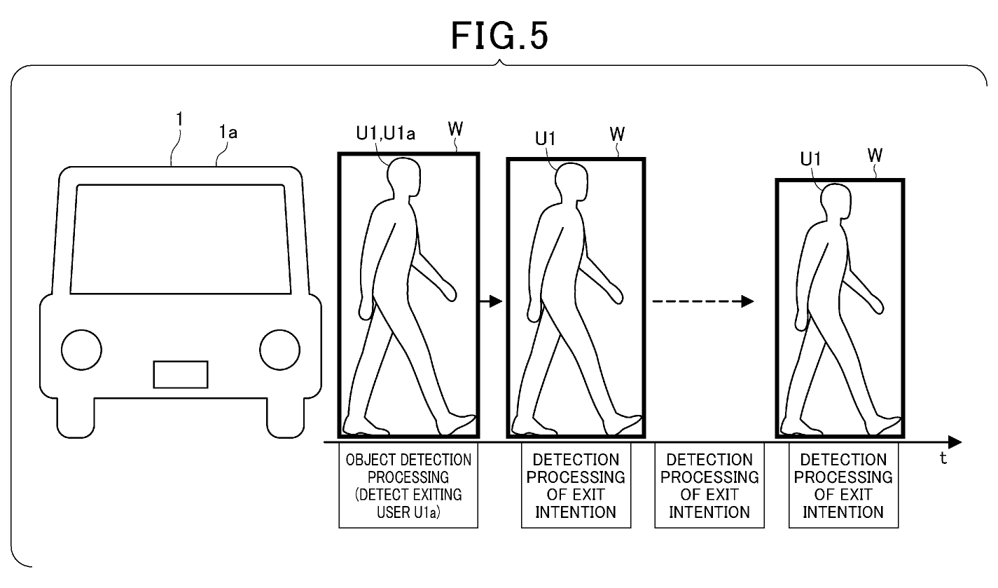

The second detection processing will be described with reference to FIG. 5. In the second detection process, as an example of the second condition, there is performed tracking of the exiting user U1a detected by the first detection processing unit 17b, and it is detected whether a condition that the frame W, which is the detection region of the exiting user U1a, shrinks over time is satisfied. The reference character t in FIG. 5 represents the time axis.

As shown in FIG. 5, since the frame W is the smallest rectangular frame that surrounds the detected person, the size of the frame W shrinks as the exiting user U1a moves away from the vehicle 1. The shrinking of the frame W can be detected based on at least one of the area, height, width, or diagonal of the frame W.

In the second detection process, a shrinking size of the exiting user U1a is detected as a shrinking of the frame W, and if the second condition is satisfied, it is determined that the exiting user U1a has moved away from the vehicle 1. This configuration makes it possible to accurately detect that the exiting user U1a has moved away from the vehicle 1 based on the captured image.

As described above, a wide-angle lens camera that images a wide horizontal range is used for camera 41a. In other words, there is used a wide-angle lens camera that can capture images of users having exited from the front and rear seats. This makes it possible to capture the exiting user U1a at a wide viewing angle. As a result, the further away the exiting user U1a is from the vehicle 1, the more the size shrinking of the exiting user U1a is emphasized, improving the accuracy of detecting whether the exiting user U1a has moved away from the vehicle 1. Therefore, it is possible to detect that the exiting user U1a has moved away from the vehicle 1 with high accuracy and in a short time.

In this embodiment, it is detected that the exiting user U1a has moved away from the vehicle 1 within the range of the target area Ar1 shown in FIG. 2, thereby making it possible to detect that the exiting user U1a has moved away from vehicle 1 before the exiting user U1a moves approximately 1.6 m away from vehicle 1.

Note that, as shown in FIG. 4, the frame W surrounding the exiting user U1a in the captured image P1 has a frame shape of nearly a square, while the frame W surrounding the passerby M1 in the captured image P2 has a vertically elongated frame shape because the passerby M1 is captured in a relatively wide range in the up-down direction. This difference in frame shape can be used to improve the accuracy of detecting whether the person is the exiting user U1a in the first detection process.

For example, as a specific first detection method, in addition to detecting that at least part of the frame W surrounding the detected person is within the predetermined region SR, a method can be performed to make it possible to improve the accuracy of detecting the exiting user U1a, the method being a method of detecting: the difference between the width and height of the frame W of the detected person is within a range of predetermined values from which the person can be inferred as a person having exited; in other words, the size of the frame W surrounding the person having exited is within a range that can be regarded as a square.

Furthermore, as a specific second detection method, in addition to detecting that at least part of the frame W surrounding the detected person is within the predetermined region SR, a method can be performed to make it possible to improve the accuracy of detecting the exiting user U1a, the method being a method of detecting: the width of the frame W of the detected person is within a range of predetermined values from which the person can be inferred as a person having exited; and the height of the frame W of the detected person is within a range of predetermined values from which the person can be inferred as a person having exited.

Note that these detection methods may be modified. For example, the methods are not limited to detecting both whether the width of the frame W of the detected person is within a range of predetermined values from which the person can be inferred as a person having exited, and whether the height of the frame W of the detected person is within a range of predetermined values from which the person can be inferred as a person having exited. The methods may include a method in which one of these is omitted. Furthermore, it may be omitted that the processing of detecting whether at least part of the frame W surrounding the detected person is within the predetermined region SR.

In addition, for the sake of convenience in description, the example of FIG. 5 shows a case where it is detected that the exiting user U1a, who is the exiting user U1a, has moved away from the vehicle 1 with an example in which the entire body of the user U1 is included in the captured image. However, the detection method is not limited to this, and even if only the upper body of user U1 is captured in the captured image, it is possible to detect that the exiting user U1a has moved away from the vehicle 1 by detecting a shrink in the detection region of user U1 (for example, a decrease in the width of the frame W).

### 3. Operation of Vehicle Control Device 10

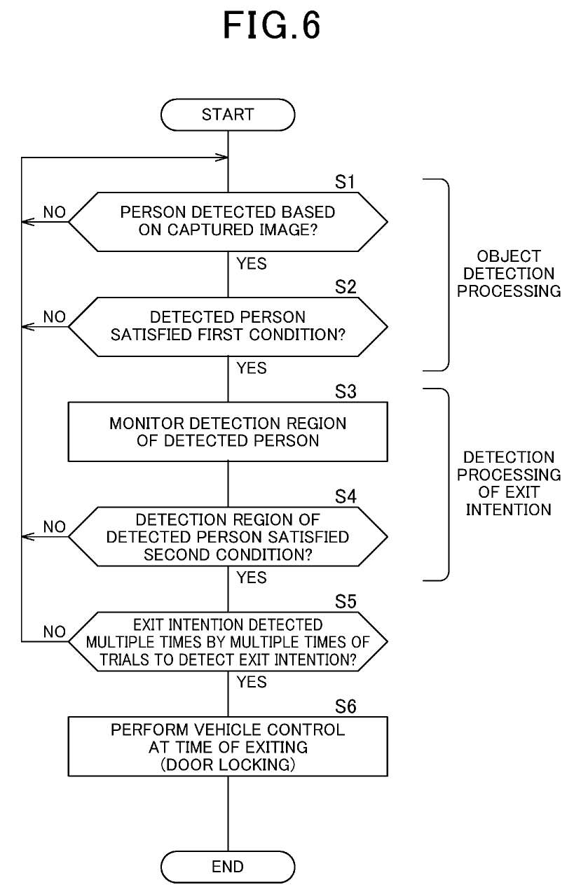

Next, the operation of the vehicle control device 10 when it executes a sequence at a time of exiting will be described in accordance with the flowchart shown in FIG. 6. Note that the processing of the flowchart shown in FIG. 6 is executed when execution of the sequence at a time of exiting is set by a user U1 or when execution of the sequence at a time of exiting is reserved. Note that the execution of the sequence at a time of exiting can be set or reserved in any appropriate manner, such as via the touch panel 34.

First, the vehicle control device 10 starts processing to detect a person with the person detection unit 16 based on the captured image captured by the camera 41a (step S1). If a person is detected (step S1: YES), the vehicle control device 10 detects whether: the person detection unit 16 detects the left door 3a; and the first condition is satisfied, the first condition indicating that the person, who is detected by the first detection processing unit 17b, is present in a position overlapping with the detected left door 3a (step S2).

The processing of steps S1 and S2 corresponds to object detection processing that detects an object composed of a person and the left door 3a. This object detection processing detects the presence or absence of an exiting user U1a, and the vehicle control device 10 repeatedly executes the object detection processing at a predetermined cycle to monitor the presence or absence of the exiting user U1a. The predetermined cycle may be set to an appropriate time within a range that allows for rapid and proper detection of the exiting user U1a.

If the exiting user U1a is detected (Step S2: YES), the vehicle control device 10, with the person tracking unit 17a, starts tracking the detected exiting user U1a, and monitors the detection region of the exiting user U1a by generating a frame W surrounding the detected exiting user U1a (Step S3).

The vehicle control device 10, with the second detection processing unit 17c, detects whether a second condition, which is a condition that the frame W shrinks over time, is satisfied (Step S4). The processing of Steps S3 and S4 corresponds to processing to detect an exit intention of an exiting user U1a.

If the second condition is satisfied, that is, when the exiting user U1a has moved away from the vehicle 1, the exit intention of the exiting user U1a is detected. This processing is repeatedly executed at a predetermined cycle, and if the exit intention is detected a predetermined number of times k or more (k is an integer equal to or greater than 2) (step S5: YES), the vehicle control device 10 confirms the exit intention with the second detection processing unit 17c.

If the exit intention is confirmed, the vehicle control device 10 controls the door control unit 15a to lock each of the doors 3a to 3d as vehicle control at a time of exiting (step S6). This allows the doors 3a to 3d to be automatically locked when the driver, who is the user U1a, has exited and moved away from the vehicle 1.

Note that the vehicle control in step S6 does not have to be limited to control of locking the doors 3a to 3d, and may include at least one of control of locking the doors 3a to 3d, control of closing the door windows, and control of closing the doors if the vehicle is equipped with a door closing function. In other words, the vehicle control in step S6 can be any vehicle control that is preferably performed at a time of exiting.

In this way, vehicle control at a time of exiting is performed after detecting the exit intention multiple times, making it possible to prevent the case where the vehicle control at a time of exiting is accidentally performed when the driver returns to the vehicle immediately after exiting. Furthermore, in this embodiment, the position of camera 41a is set so that it can capture an image of a person within the target area Ar1 shown in FIG. 2, making it easier to detect the exit intention multiple times before exiting user U1a exits the target area Ar1. Note that the time interval for checking the exit intention and the number of times (k) for checking the exit intention may be set as appropriate.

As shown in FIG. 6, if a negative result is obtained in any of the above steps S1, S2, S4, or S5, the vehicle control device 10 proceeds to the process of step S1. This can prevent the case where the vehicle control is accidentally performed at a time of exiting, any of when a user other than the driver exits and when a passerby M1, who is traveling along any routes RT1 to RT5 and the like shown in FIG. 2, passes through the target area Ar1.

As described above, the exit detection unit 17 of this embodiment performs a first detection process to detect whether a first condition is satisfied, the first condition indicating that the detected person is present near the left door 3a of the vehicle 1, and a second detection process to detect whether a second condition is satisfied, the second condition indicating that the detected person is moving away from the vehicle 1, based on the image captured by the camera 41a that images the left side of the vehicle 1. Then, if the first and second conditions are satisfied, the vehicle control unit 15 performs vehicle control at a time of exiting.

Detecting the driver exiting from vehicle 1 in this manner makes it possible to properly detect the driver exiting from vehicle 1 even in a situation where a passerby is present. This allows for appropriate vehicle control at a time of exiting, improving convenience.

Furthermore, the exit detection unit 17 tracks the detected person and determines that the second condition is satisfied if the frame W, which is the detection region of the person, shrinks over time. This makes it possible to detect the driver exiting from vehicle 1 based on conditions of tracking of a person present near the left door 3a and shrinking of the detection region. Therefore, this makes it possible to more properly detect the driver exiting from vehicle 1 even in a situation where a passerby is present.

Furthermore, the first condition includes that the detected person overlaps with the left door 3a. This allows for highly accurate detection of the driver having exited based on the captured image in which the driver who has opened the left door 3a and exited overlaps with the left door 3a. Furthermore, because the image captured from inside the open left door 3a is used, it is easier to distinguish between a passerby and the driver, further improving accuracy of detecting the driver.

Furthermore, the first condition also includes that at least part of the detection region of the detected person is within the predetermined region SR at the lower part in the captured image. This allows the driver having exited to be detected with high accuracy based on the captured image in which at least part of the driver having exited is captured in the predetermined region SR at the lower part in the captured image. This makes it easier to distinguish between the driver having exited and a passerby, further improving detection accuracy.

Furthermore, the captured image is an image in which the driver having exited appears in the predetermined region SR at the lower part in the captured image, and a passerby located around the vehicle 1 appears outside the predetermined region SR, improving accuracy of detecting the driver having exited the vehicle.

Furthermore, the exit detection unit 17 determines that a detected person is a passerby if the detected person does not overlap with the left door 3a in the captured image, and/or if the frame W, which is the detection region of the detected person, is not within the predetermined region SR at the lower part in the captured image. This makes it easier to distinguish between the driver having exited and a passerby, improving detection accuracy.

Furthermore, the captured image is an image captured by a camera 41a attached at a position of the center pillar 1c or around the center pillar 1c on the driver's seat 2a side. The exit detection unit 17 determines that the person detected by the person detection unit 16 is a person having exited if the person is detected in a position overlapping with the left door 3a, which is the door on the front seat side, in the captured image. This makes it possible to detect the person exiting from the driver's seat 2a with high accuracy.

Furthermore, the first condition includes that the detected person overlaps with the left door 3a in the captured image, and that at least part of the detection region of the detected person is within the predetermined region SR at the lower part in the captured image. The predetermined region SR is a region on either the left side or the right side (the right side in this embodiment) at the lower part in the captured image. These improve the accuracy of detecting the person having exited.

The captured image also includes the center pillar 1c, which is a peripheral member of the door opening to be closed by the left door 3a. The first condition includes satisfying either the condition that the detected person overlaps with the left door 3a in the captured image, or the condition that the detected person overlaps with the peripheral member in the captured image. This makes it possible to image a person immediately after exiting from the door opening, and to rapidly detect the person having exited.

Note that the peripheral member of the door opening that appears in the captured image is not limited to the side rail 1e, and may be, for example, the front pillar 1b and/or the center pillar 1c.

Furthermore, the first condition also includes that the width of the frame W, which is the detection region of the detected person, is within a range of predetermined values from which the person can be inferred as a person having exited. This makes it possible to detect a person having exited with high accuracy based on the width of the frame W in the captured image.

The first condition also includes that the height of the frame W of the detected person is within a range of predetermined values from which the person can be inferred as a person having exited. This makes it possible to detect a person having exited with high accuracy based on the height of the frame W in the captured image.

The first condition also includes the difference between the width and height of the frame W of the detected person is within a range of predetermined values from which the person can be inferred as a person having exited. This makes it possible to detect a person having exited with high accuracy based on the difference between the width and height of the frame W in the captured image.

The predetermined region SR is set at the width direction end portion and at a position away from the upper end of the left door 3a of the vehicle 1, and overlaps with the detection region of a person having exited. On the other hand, the predetermined region SR can be set at a position with which a detection region of a passerby is unlikely to overlap, making it possible to reduce the number of cases where a passerby is mistakenly recognized for an occupant having exited.

The vehicle control unit 15 also includes a door control unit 15a that performs control of locking the doors 3a to 3d, including the left door 3a, as vehicle control at a time of exiting. As a result, the doors 3a to 3d can be automatically locked when a person having exited is detected.

In detecting the driver exiting a right-hand drive vehicle, or in detecting a person exiting the passenger seat 2b of a left-hand drive vehicle, similar processing only needs to be performed based on the image captured by the right camera 41b.

For example, the exit detection unit 17 performs, based on the image captured by camera 41b that captures the right side of the vehicle 1, a first detection processing to detect whether a detected person satisfies a first condition that the person is present near the right door 3b of the vehicle 1, and a second detection processing to track the detected person to detect whether a second condition is satisfied, the second condition indicating that the frame W, which is the detection region of the person, shrinks over time. Then, if the first and second conditions are satisfied, the vehicle control unit 15 performs vehicle control at a time of exiting. This makes it possible to properly detect the driver exiting from the vehicle 1 or a person exiting from the passenger seat 2b even in a situation where a passerby is present. Therefore, vehicle control can be performed appropriately at a time of exiting, improving convenience.

In this case, the first condition includes that the detected person overlaps with the right door 3b in the captured image and at least part of the detection region of the detected person is within a predetermined region at the lower part in the captured image. The predetermined region SR is either the left region or the right region (left region here) at the lower part in the captured image. This makes it possible to detect the driver exiting with high accuracy in the case of a right-hand drive vehicle. Furthermore, this makes it possible to detect the person exiting from the passenger seat 2b with high accuracy in the case of a left-hand drive vehicle.

The vehicle 1 shown in FIG. 1 and others is an example of a target vehicle in the present disclosure, and the left door 3a and/or the right door 3b are examples of target doors in the present disclosure.

Furthermore, the processing performed by the person detection unit 16 is an example of a person detection step in the present disclosure, the processing performed by the exit detection unit 17 is an example of an exit detection step in the present disclosure, and the processing performed by the vehicle control unit 15 is an example of a vehicle control step in the present disclosure.

### 4. Other Embodiments

The above embodiment is merely an aspect of the present invention, and any modifications and applications are possible without departing from the spirit and scope of the present invention.

For example, in the above embodiment, the vehicle control at a time of exiting is described with a case of performing control of locking the doors 3a to 3d, but the vehicle control at a time of exiting is not limited to this. For example, in addition to or instead of performing control of locking the doors 3a to 3d, control may be performed to close the door windows of the doors 3a to 3d, or door closing control may be performed to close an open door among the doors 3a to 3d if a door closing function is provided.

Furthermore, the configuration shown in FIG. 3 and the like can include a configuration implemented by software, a configuration implemented by hardware, and a configuration implemented by a combination of software and hardware, in a wide range of ways. Furthermore, the division of processing units and the processing order in the flowchart are not limited to the illustrated example and may be modified as appropriate.

In addition, the present invention has been described as being applied to the vehicle system 100 and a vehicle control method for a four-wheeled automobile shown in FIG. 1. However, the present invention is not limited to this and may also be applied to vehicle systems and vehicle control methods for other vehicles.

In addition, the program 22 implementing the vehicle control method of the present invention is described as being recorded in the vehicle control device 10, but the program 22 may also be acquired from an external device via communication. The program 22 may also be recorded on a computer-readable recording medium. The recording medium to be used may be a magnetic or optical recording medium, or a semiconductor memory device. Specific examples include portable or fixed recording media such as flexible disks, various optical disks, magneto-optical disks, flash memory, and card recording media. The recording medium may also be a non-volatile storage device such as a RAM, a ROM, or an HDD, which is an internal storage device provided in an image display device.

### 5. Configuration Supported by Above Embodiments

The above embodiments are specific examples of the following configurations.

### Configuration 1

A vehicle system including: a person detection unit that detects a person based on a captured image composed of a moving image captured outside a vehicle; an exit detection unit that detects whether the detected person is a person having exited from a target vehicle, wherein the exit detection unit performs, based on the captured image, a first detection processing of detecting whether a first condition is satisfied, the first condition indicating that the detected person is present near a target door of the target vehicle, and a second detection processing of detecting whether a second condition is satisfied, the second condition indicating that the detected person is moving away from the target vehicle, and detects the detected person as a person having exited from the target vehicle when the first condition and the second condition are satisfied; and a vehicle control unit that performs vehicle control at a time of exiting when the exit detection unit detects that the detected person is a person having exited from the target vehicle.

This configuration makes it possible to properly detect the person exiting from the target vehicle even in a situation where a passerby is present, to appropriately perform vehicle control and improve convenience.

### Configuration 2

The vehicle system according to configuration 1, wherein the exit detection unit tracks the detected person and determines that the second condition is satisfied when a detection region of the person shrinks over time.

This configuration makes it possible to detect the person exiting from the target vehicle based on conditions of tracking the person present near the target door and shrinking of the detection region. Therefore, this makes it possible to more properly detect the person exiting from the target vehicle even in a situation where a passerby is present.

### Configuration 3

The vehicle system according to configuration 1, wherein the first condition includes that the detected person overlaps with the door in the captured image.

This configuration makes it possible to detect the driver having exited with high accuracy based on the captured image in which the occupant who has opened the door and has exited overlaps with the door.

### Configuration 4

The vehicle system according to configuration 1 or 2, wherein the first condition includes that at least part of a detection region of the detected person is within a predetermined region at a lower part in the captured image.

This configuration makes it possible to detect the occupant having exited with higher accuracy based on a captured image in which at least part of the occupant appears within a predetermined region at the lower part in the captured image.

### Configuration 5

The vehicle system according to configuration 4, wherein the captured image is an image in which a person having exited is captured in the predetermined region in the captured image, and a passerby located around the vehicle is imaged outside the predetermined region.

This configuration improves the accuracy of detecting the occupant having exited.

### Configuration 6

The vehicle system according to configuration 3, wherein the exit detection unit determines that the detected person is a passerby when the detected person does not overlap with the door in the captured image and/or when a detection region of the detected person is not within a predetermined region at a lower part in the captured image.

This configuration makes it easier to distinguish between the occupant having exited and a passerby, improving detection accuracy.

### Configuration 7

The vehicle system according to any one of configurations 1 to 6, wherein the captured image is an image captured by an exterior-imaging camera attached at a position of or around a center pillar that is positioned midway between a front and a rear of the target vehicle, and the exit detection unit determines that the person detected by the person detection unit is the person having exited when the person is detected in a position overlapping with a door on a front seat side in the captured image.

This configuration makes it possible to detect the person exiting from a front seat with high accuracy.

### Configuration 8

The vehicle system according to configuration 7, wherein the first condition includes that the detected person overlaps with the door in the captured image, and at least part of a detection region of the detected person is within a predetermined region at a lower part in the captured image, and the predetermined region is either a left region or a right region at a lower part in the captured image.

This configuration makes it possible to detect the person exiting from a front seat with high accuracy.

### Configuration 9

The vehicle system according to any one of configurations 1 to 8, wherein the captured image includes a peripheral member of a door opening to be closed by the door, and the first condition includes satisfying either one of the following: the detected person overlaps with the door in the captured image; and the detected person overlaps with the peripheral member in the captured image.

This configuration makes it possible to image the person immediately after exiting from the door opening, and to rapidly detect the person having exited.

### Configuration 10

The vehicle system according to any one of configurations 1 to 9, wherein the first condition includes that a width of a detection region of the detected person is within a range of predetermined values from which the width can be inferred as a width of the detection region of a person having exited.

This configuration makes it possible to detect the person having exited with high accuracy based on the width of the detection region in the captured image.

### Configuration 11

The vehicle system according to any one of configurations 1 to 10, wherein the first condition includes that a height of a detection region of the detected person is within a range of predetermined values from which the person can be inferred as a person having exited.

This configuration makes it possible to detect the person having exited with high accuracy based on the height of the detection region in the captured image.

### Configuration 12

The vehicle system according to any one of configurations 1 to 11, wherein the first condition includes that a difference between a width and a height of a detection region of the detected person is within a range of predetermined values from which the person can be inferred as a person having exited.

This configuration makes it possible to detect the person having exited with high accuracy based on the difference between the width and height of the detection region in the captured image.

### Configuration 13

The vehicle system according to configuration 4 or 5, wherein the predetermined region is set at a width direction end portion and a position away from an upper end of the target door of the target vehicle.

This configuration makes it possible to set the predetermined region at a position where the detection regions of persons having exited overlap, but are unlikely to overlap with the detection region of a passerby, reducing the case where passerby is mistakenly recognized for occupants having exited.

### Configuration 14

The vehicle system according to any one of configurations 1 to 13, wherein the vehicle control unit includes a door control unit that performs lock control of doors including the target door, as the vehicle control at a time of exiting.

This configuration makes it possible to automatically lock the door when the person having exited is detected.

### Configuration 15

A vehicle control method executed by a computer, the method including: a person detection step of a person detection unit detecting a person based on a captured image composed of a moving image captured outside a vehicle; an exit detection step of an exit detection unit detecting whether the detected person has exited from a target vehicle; and a vehicle control step of a vehicle control unit performing vehicle control at a time of exiting when the detected person is detected as a person having exited from the target vehicle, wherein the exit detection step performs, based on the captured image, a first detection processing of detecting whether a first condition is satisfied, the first condition indicating that the detected person is present near a target door of the target vehicle, and a second detection processing of detecting whether a second condition is satisfied, the second condition indicating that the detected person is moving away from the target vehicle, and detects the detected person as a person having exited from the target vehicle when the first condition and the second condition are satisfied.

This configuration makes it possible to properly detect the person exiting from the target vehicle even in a situation where a passerby is present, to appropriately perform vehicle control and improve convenience.

### Reference Signs List

1... vehicle, 1a... vehicle body, 1b... front pillar, 1c... center pillar, 1d... rear pillar, 1e... side rail, 2a... driver's seat (front seat), 2b... passenger seat (front seat), 2c to 2e... rear seats, 3a... left door (target door), 3b... right door, 4a to 4d... door lock mechanisms, 12... information acquisition unit, 13... operation input unit, 15... vehicle control unit, 15a... door control unit, 16... person detection unit, 17... exit detection unit, 17a... person tracking unit, 17b... first detection processing unit, 17c... second detection processing unit, 41a, 41b... cameras, 100... vehicle system, Ar1... target area, U1 to U2... users, U1a... exiting user, M1... passerby, P1, P2... captured images, S... vehicle interior, V... other vehicle, W... frame, SR... predetermined region.

What is claimed is:

1. A vehicle system comprising:
a person detection unit that detects a person based on a captured image composed of a moving image captured outside a vehicle;
an exit detection unit that detects whether the detected person is a person having exited from a target vehicle,
wherein the exit detection unit performs, based on the captured image, a first detection processing of detecting whether a first condition is satisfied, the first condition indicating that the detected person is present near a target door of the target vehicle, and a second detection processing of detecting whether a second condition is satisfied, the second condition indicating that the detected person is moving away from the target vehicle, and detects the detected person as a person having exited from the target vehicle when the first condition and the second condition are satisfied; and
a vehicle control unit that performs vehicle control at a time of exiting when the exit detection unit detects that the detected person is a person having exited from the target vehicle.

2. The vehicle system according to claim 1, wherein the exit detection unit tracks the detected person and determines that the second condition is satisfied when a detection region of the person shrinks over time.

3. The vehicle system according to claim 1, wherein the first condition includes that the detected person overlaps with the door in the captured image.

4. The vehicle system according to claim 1, wherein the first condition includes that at least part of a detection region of the detected person is within a predetermined region at a lower part in the captured image.

5. The vehicle system according to claim 4, wherein the captured image is an image in which a person having exited is captured in the predetermined region in the captured image, and a passerby located around the vehicle is imaged outside the predetermined region.

6. The vehicle system according to claim 3, wherein the exit detection unit determines that the detected person is a passerby when the detected person does not overlap with the door in the captured image and/or when a detection region of the detected person is not within a predetermined region at a lower part in the captured image.

7. The vehicle system according to claim 1, wherein
the captured image is an image captured by an exterior-imaging camera attached at a position of or around a center pillar that is positioned midway between a front and a rear of the target vehicle, and
the exit detection unit determines that the person detected by the person detection unit is the person having exited when the person is detected in a position overlapping with a door on a front seat side in the captured image.

8. The vehicle system according to claim 7, wherein
the first condition includes that the detected person overlaps with the door in the captured image, and at least part of a detection region of the detected person is within a predetermined region at a lower part in the captured image, and
the predetermined region is either a left region or a right region at a lower part in the captured image.

9. The vehicle system according to claim 1, wherein
the captured image includes a peripheral member of a door opening to be closed by the door, and
the first condition includes satisfying either one of the following: the detected person overlaps with the door in the captured image; and the detected person overlaps with the peripheral member in the captured image.

10. The vehicle system according to claim 1, wherein the first condition includes that a width of a detection region of the detected person is within a range of predetermined values from which the width can be inferred as a width of the detection region of a person having exited.

11. The vehicle system according to claim 1, wherein the first condition includes that a height of a detection region of the detected person is within a range of predetermined values from which the person can be inferred as a person having exited.

12. The vehicle system according to claim 1, wherein the first condition includes that a difference between a width and a height of a detection region of the detected person is within a range of predetermined values from which the person can be inferred as a person having exited.

13. The vehicle system according to claim 4, wherein the predetermined region is set at a width direction end portion and a position away from an upper end of the target door of the target vehicle.

14. The vehicle system according to claim 1, wherein the vehicle control unit includes a door control unit that performs lock control of doors including the target door, as the vehicle control at a time of exiting.

15. A vehicle control method executed by a computer, the method comprising:
a person detection step of a person detection unit detecting a person based on a captured image composed of a moving image captured outside a vehicle;
an exit detection step of an exit detection unit detecting whether the detected person has exited from a target vehicle; and
a vehicle control step of a vehicle control unit performing vehicle control at a time of exiting when the detected person is detected as a person having exited from the target vehicle,
wherein the exit detection step performs, based on the captured image, a first detection processing of detecting whether a first condition is satisfied, the first condition indicating that the detected person is present near a target door of the target vehicle, and a second detection processing of detecting whether a second condition is satisfied, the second condition indicating that the detected person is moving away from the target vehicle, and detects the detected person as a person having exited from the target vehicle when the first condition and the second condition are satisfied.
